(19) United States
(12) Patent Application Publication
(10) Pub. No.: US 2026/0231947 A1
(43) Pub. Date: Aug. 13, 2026

(54) IMPROVED BIOCIDE COMPOSITIONS

(71) Applicant: Solugen, Inc., Houston, TX (US)

(72) Inventors: Jun Su An, Houston, TX (US); LoongYi Tan, Houston, TX (US); Jason Helander, Richmond, TX (US); Frederyk Ngantung, Houston, TX (US); Sean Hunt, Houston, TX (US); Gaurab Chakrabarti, Houston, TX (US)

(73) Assignee: Solugen, Inc., Houston, TX (US)

(21) Appl. No.: 18/287,877

(22) PCT Filed: Apr. 25, 2022
(86) PCT No.: PCT/US2022/026218

§ 371 Date: Oct. 21, 2023

Related U.S. Application Data
(60) Provisional application No. 63/179,166, filed on Apr. 23, 2021.

(51) Int. Cl. A01N 57/20; A01N 33/12; A01N 59/08; A01P 1/00; C02F 1/50; C02F 1/68; C02F 101/10; C02F 103/02

(52) U.S. Cl. CPC A01N 57/20; A01N 33/12; A01N 59/08; A01P 1/00; C02F 1/50; C02F 1/683; C02F 2101/10; C02F 2103/023; C02F 2303/04; C02F 2303/20; C02F 2303/22

(57) ABSTRACT

A method of treating process water includes introducing to a system comprising process water a composition comprising (i) one or more biocides and (ii) one or more biochelants. A composition includes (i) one or more biocides and (ii) one or more biochelants. A pharmaceutical formulation includes (i) one or more biocides, (ii) one or more biochelants, and (iii) a pharmaceutically acceptable diluent.

### CROSS-REFERENCE TO RELATED APPLICATIONS

This application is a 35 U.S.C. § 371 national stage application of PCT/US2022/026218 filed Apr. 25, 2022, and entitled “IMPROVED BIOCIDE COMPOSITIONS,” which claims priority to U.S. Provisional Application Ser. No. 63/179,166 filed Apr. 23, 2021 and entitled “BIOCIDE COMPOSITIONS,” each of which is hereby incorporated herein by reference in its entirety for all purposes.

### TECHNICAL FIELD

The present disclosure generally relates to compositions and methods for reducing microbial populations. More specifically, the present disclosure relates to compositions and methods for use in conjunction with one or more additional biocides.

### BACKGROUND

Oil and gas production and industrial temperature control systems (e.g., heating or cooling towers) are examples of water-intensive commercial operations that face challenges with the growth of microorganisms in the water systems. Methods of addressing these challenges have largely focused on finding a stable, dynamic balance in keeping microbial growth at an acceptable level in a cost-efficient manner as opposed to complete sterilization of the process water. Whether the microorganisms are free-floating or aggregated into larger structures such as biofilms, the presence of a significant amount of microorganisms can have adverse results such as unscheduled down-time of the machinery due to cleaning, clogging of pipelines or valves or spray nozzles, poor heat transfer, high energy consumption, corrosion, increased maintenance expenditures, shortened system life, and/or higher operating costs.

An ongoing need exists for novel biocidal compositions and methods of using same to address the challenge of microorganism build up in systems utilizing process water.

### SUMMARY

Disclosed herein is a method of treating process water comprising introducing to a system comprising process water a composition comprising (i) one or more biocides and (ii) one or more biochelants.

Also disclosed herein is a composition comprising (i) one or more biocides and (ii) one or more biochelants.

Also disclosed herein is a pharmaceutical formulation comprising (i) one or more biocides (ii) one or more biochelants and (iii) a pharmaceutically acceptable diluent.

### DETAILED DESCRIPTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

Groups of elements of the periodic table are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens for Group 17 elements, among others.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials that do not significantly alter the composition or method to which the term is applied. While compositions and methods are described in terms of “comprising” various components or steps, the compositions and methods can also “consist essentially of” or “consist of” the various components or steps.

In the specification and claims, the terms “a,” “an,” and “the” are intended, unless specifically indicated otherwise, to include plural alternatives, e.g., at least one, or one or more.

Disclosed herein are biocide compositions. A biocide herein refers to an antimicrobial chemical substance which can deter, render harmless, or exert a controlling effect on any harmful organism. A biocide may be further classified e.g. as a germicide, an antibacterial, an antiviral, an antifungal, an antiprotozoal or an antiparasite. In some of the aspects disclosed herein, the biocide compositions may exhibit improved function and/or efficacy in comparison to the biocide alone.

In one or more aspects, the compositions disclosed herein reduce the amount of biocide needed to inhibit or prevent the growth of microorganisms in a process water. Herein “process water,” also referred to as “industrial water”, refers to water used in industrial processes, manufacturing processes, power generation, and similar applications. Hereinafter, the compositions disclosed are termed compositions characterized as an improved biocidal formulation and designated IBF.

In an aspect, the IBF comprises (i) a biocide and (ii) a biochelant. An IBF of the type disclosed herein may display a minimum inhibitory concentration (MIC) for microorganism growth that is reduced by from about 5% to about 100%, alternatively from about 15% to about 90% or alternatively from about 20% to about 80% when compared to the MIC of the biocide in the absence of the biochelant. The MIC refers to the lowest concentration of a chemical which prevents visible growth of a microorganism (e.g., bacterium or bacteria).

In an aspect, the IBF comprises a biocide. Any biocide may be a component of the IBF assuming it is compatible with the other components of the IBF. In an aspect, the biocide comprises aldehydes, quaternary ammonium cations, brominated organic compounds, phosphonium salts, hydrogen peroxide, peracetic acid, bleach, derivatives thereof, or a combination thereof.

Nonlimiting examples of biocides suitable for use in the present disclosure include glutaraldehyde, quaternary ammonium compounds, tetrakis hydroxymethyl-phosphonium sulfates, tetrakis hydroxymethyl-phosphonium chlorides, bronopol, bleach, bromines, hydrogen peroxide, peracetic acid, citric acid, 2,2-dibromo-3-nitrilopropionamide (DBNPA), (+)-tartaric acid, (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (13Z)-Hexadec-13-en-11-yn-1-yl acetate, (9Z,12E)-tetradeca-9,12-dien-1-yl acetate, (benzothiazol-2-ylthio)methyl thiocyanate (TCMTB), benzyloxy)methanol, ((E)-1-(2-Chloro-1,3-thiazol-5-ylmethyl)-3-methyl-2-nitroguanidine (Clothianidin), (ethylenedioxy)dimethanol (Reaction products of ethylene glycol with paraformaldehyde (EGForm)), (RS)-3-Allyl-2-methyl-4-oxocyclopent-2-enyl (1R,3R)-2,2-dimethyl-3-(2-methyl prop-1-enyl)-cyclopropanecarboxylate (mixture of 2 isomers 1R trans: 1R/S only 1:3) (Esbiothrin), (1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1) (d-Allethrin), (RS)-α-cyano-3phenoxybenzyl-(1 RS)-cis, trans-3-(2,2-dichlorovinyl)-2,2-dimethylcyclopropanecarboxylate (Cypermethrin), 1,2-benzisothiazol-3(2H)-one (BIT), 1,3-bis(hydroxymethyl)-5,5-dimethylimidazolidine-2,4-dione (DMDMH), 1-[2-(allyloxy)-2-(2,4-dichlorophenyl)ethyl]-1H-imidazole (Imazalil), 2,2-dibromo-2-cyanoacetamide (DBNPA), 2,2′,2″-(hexahydro-1,3,5-triazine-1,3,5-triyl)triethanol (HHT), 4,4-dimethyloxazolidine, 4,5-Dichloro-2-octylisothiazol-3(2H)-one (4,5-Dichloro-2-octyl-2H-isothiazol-3-one (DCOIT)), 4-bromo-2-(4-chlorophenyl)-1-ethoxy methyl-5-trifluoromethylpyrrole-3-carbonitrile (Chlorfenapyr), 4-bromo-2-(4-chlorophenyl)-1-ethoxy methyl-5-trifluoromethylpyrrole-3-carbonitrile, 5-chloro-2-(4-chlorphenoxy)phenol (DCPP), 6-(phthalimido)peroxyhexanoic acid (PAP), 7a-ethyldihydro-1H,3H,5H-oxazolo[3,4-c]oxazole (EDHO), tetrakis(hydroxymethyl)phosphonium sulfate (THPS), and tetrakis(hydroxymethyl)phosphonium chloride (THPC).

The biocide may be used in an amount effective to produce some user and/or process goal. As will be understood by one of ordinary skill in the art, various factors affect the amount of biocide present in the IBF and the dosage utilized. For example, factors such as the particular biocide being used, the particular microorganism being treated and the amount of microorganism present.

In an aspect, the IBF comprises a chelant. Herein a chelant, also termed a sequestrant, a chelating agent or sequestering agent, refers to a molecule capable of bonding or forming a complex with a metal. The chelant may be characterized as a ligand that contains two or more electron-donating groups so that more than one bond is formed between an atom on each of the electron donating groups of the ligand to the metal. This bond can also be dative or a coordinating covalent bond meaning each electronegative atom provides both electrons to form bonds to the metal center. In an aspect, the chelant is a biochelant. As used herein, the prefix “bio” indicates that the chemical is produced by a biological process such as using an enzyme catalyst.

In an aspect, the biochelant comprises aldonic acid, uronic acid, aldaric acid, or a combination thereof and a counter cation. For example, the biochelant may be a mixture of aldaric, uronic acids, and their respective counter-cations.

In an aspect, the biochelant comprises a glucose oxidation product, a gluconic acid oxidation product, a gluconate, or a combination thereof. The glucose oxidation product, gluconic acid oxidation product, or combination thereof may be buffered to a suitable pH.

Additionally or alternatively, in one or more aspects, the biochelant comprises glucaric acid, gluconic acid, glucuronic acid, glucose oxidation products, gluconic acid oxidation products or a combination thereof. Additionally or alternatively, in one or more aspects, the biochelant comprises disaccharides, oxidized disaccharides, uronic acid, aldaric acid or a combination thereof.

Additionally or alternatively, in one or more aspects, the biochelant comprises gluconic acid, glucaric acid, glucuronic acid, n-keto-acids, C₂ to C₆ diacids or a combination thereof.

Additionally or alternatively, in one or more aspects, the biochelant comprises galactonic acid, galactaric acid, an oxidation product comprising predominantly (e.g., greater than about 50 weight percent) galactonic acid and/or galactaric acid with minor component species of n-keto-acids, C₂ to C₆ diacids or a combination thereof. Additionally or alternatively, in one or more aspects, the biochelant comprises glutamic acid. Additionally or alternatively, in one or more aspects, the biochelant comprises glucodialdose, 2-ketoglucose or a combination thereof.

In such aspects, the buffered glucose oxidation product, the buffered gluconic acid oxidation product, or combinations thereof are buffered to a suitable pH. For example, the glucose oxidation product, gluconic acid oxidation product or combination thereof may be buffered to a pH in the range of from about 1 to about 5. Buffering of the chelant may be carried using any suitable acid, base or combination thereof.

In one or more aspects, any biochelant or combination of biochelants disclosed herein may further comprise a counter-cation such as a Group 1 alkali metal, a Group 2 alkaline earth metal, a Group 8 metal, Group 11 metal, Group 12 metal or a combination thereof. For example, the counter-cation may comprise silicates, borates, aluminum, calcium, magnesium, ammonium, sodium, potassium, cesium, strontium, zinc, copper, ferric iron or ferrous iron or a combination thereof.

In an aspect, the biochelant comprises a glucose oxidation product, a gluconic acid oxidation product, a gluconate, glucaric acid, an oxidized glucuronolactone, a uronic acid oxidation product or a combination thereof. Alternatively, the biochelant comprises a buffered glucose oxidation product, a buffered gluconic acid oxidation product or combinations thereof. In some such aspects, the buffered glucose oxidation product, the buffered gluconic acid oxidation product, or combinations thereof are buffered to a pH within a range disclosed herein with any suitable acid or base such as sodium hydroxide. In an example of such aspects, the biochelant comprises a mixture of gluconic acid and glucaric acid and further comprises a minor component species comprising n-keto-acids, C₂-C₆ diacids or combinations thereof. In an aspect, the biochelant comprises a metal chelation product commercially available from Solugen, Houston Texas as BIOCHELATE™.

In various aspects, the chelant may be present in the IBF in an amount of from about 5 weight percent (wt. %) to about 70 wt. %, alternatively, from about 5 wt. % to about 70 wt. %, alternatively, from about 5 wt. % to about 30 wt. %, or alternatively, from about 20 wt. % to about 40 wt. % based on the total weight of the IBF. Herein, all weight percentages are based on the total weight of the composition being described unless indicated otherwise.

In one or more aspects, the biocide and biochelant are present in amounts effective to treat the targeted microorganism(s) when added to a process water (such as in a cooling tower). The ratio of biocide:biochelant may range from about 1:100 to about 100:1, alternatively from about 10:90 to about 90:10, alternatively from about 20:80 to about 80:20, alternatively from about 30:70 to about 70:30, alternatively from about 40:60 to about 60:40 or alternatively about 50:50.

In an aspect, an IBF of the type disclosed herein may further comprise a solvent. In some aspects, the solvent is an organic compound such as a glycol or alcohol. In the alternative, the solvent comprises an aqueous fluid. The aqueous fluid may comprise fresh water, salt water, deionized water, produced water, flowback water, brackish water, brine, seawater, or a combination thereof. In an aspect, the solvent comprises the remainder of the IBF when all other components are accounted for.

In an aspect, an IBF may be introduced to any system comprising a volume of process water, for example, in order to mitigate the growth of one or more microbial organisms. For example, applications of process water that may be treated using an IBF include water used in thermoelectric power plants, manufacturing plants, ore and oil refineries, and hydroelectric dams. Water used in these processes and/or systems can function as a coolant, a solvent, and/or a chemical reagent.

The IBF may be introduced to a system or one or more components thereof that utilizes process water, such as and without limitation cooling towers, boilers, evaporators, heat exchangers, chillers, reverse osmosis/filtration systems, and distillation/separation processes. Additionally or alternatively, in an aspect, the IBF may be introduced to the process water used in oilfield servicing such as produced water.

Utilization of the IBF in a system may be carried out by introducing the IBF to a system comprising process water in a batch mode, in a continuous fashion, or on the fly based on some user and/or process goal or some user and/or process observation. For example, the level of one or more microorganisms and/or IBF concentration in a system may be monitored continuously (e.g., via sensor) or at intervals, and the IBF introduced to the system to maintain some user and/or process desired microbial level or IBF concentration.

It is contemplated that IBFs of the present disclosure have extended applicability in products such as disinfectants, sanitizers and cleaners. Other nonlimiting applications for IBFs include insect repellent, antimicrobial, attractant, sterilizer, disinfectant, sanitizer, fungicide, nematocide, fumigant, herbicide, defoliant, desiccant, antifoulant, insecticide, rodenticide, algaecide, preservative, molluscicide and water.

In an aspect, the IBF may contain additional ingredients that make it suitable for administration to a subject. As used herein, “additional ingredients” include, but are not limited to, one or more of the following: excipients; surface active agents; dispersing agents; inert diluents; granulating and disintegrating agents; binding agents; lubricating agents; sweetening agents; flavoring agents; coloring agents; preservatives; physiologically degradable compositions such as gelatin or anandamide itself; aqueous vehicles and solvents; oily vehicles and solvents; suspending agents; dispersing or wetting agents; emulsifying agents, demulcents; buffers; salts; thickening agents; fillers; emulsifying agents; antioxidants; antibiotics; antifungal agents; stabilizing agents; and other pharmaceutically polymeric composition or hydrophobic material.

In one or more aspects, an IBF of the type disclosed herein is formulated for topical use such as on surfaces (e.g., table, skin). In one or more aspects, an IBF is formulated for use as an ingestible material that can address one or more medical conditions (e.g., antifungal).

In one or more aspects, the IBF may be formulated for treatment of a mammalian subject. The term “subject” as used herein, refers to an animal which is the object of treatment, observation, or experiment. By way of example only, a subject may be, but is not limited to, a mammal including, but not limited to, a human. In an aspect, the subject is administered the compositions disclosed herein in a therapeutically effective amount. It is contemplated that the therapeutically effective amount may be optimized by one or more healthcare professionals in consideration of the particular factors affecting a subject. For example, the IBF may be utilized by a subject as a hand sanitizer.

In an aspect, an IBF of the type disclosed herein is characterized by a performance improvement while delivering a lower environmental impact. Furthermore, the use of less biocide in order to obtain similar microorganism inhibition or prevention provides economic advantages. Additionally, the benefits associated with the IBF may also lead to improved efficacy for controlling emerging pathogens and organisms.

Additional advantages are observed with the use of an IBF of the type disclosed herein. Specifically, the biochelant component of the IBF may be a glucose oxidation product which is readily biodegradable. Therefore, it reduces the overall environmental impact associated with the formation and utilization of the IBF. It is typically considered that the use of a biodegradable chelant with a biocide would result in detrimental effects to the biocide, as the biodegradable chelants may act as a metabolite source for the microorganism, especially biochelants of the type disclosed herein. However, the results presented herein unexpectedly and advantageously demonstrate otherwise.

An IBF of the type disclosed herein resulted in an unexpected performance boost in biocidal activity when compared to the biocidal component in the absence of the biochelant. IBFs of the type disclosed herein can beneficially lead to a higher biocide efficacy and/or a lower effective biocide dosage. Such benefits of the presently disclosed IBFs allow for biocides to be used in a more efficient manner such as allowing stocks of biocide to last longer, supply chains to be simplified and streamlined, and for more lean practices to be observed. In an aspect, IBFs of the type disclosed herein have the ability to improve the killing or efficacy of (as indicated by a reduced MIC) against emerging organisms. In an aspect, the IBF disclosed herein may be a component of a consumer product or end-use article such as a liquid spray, a liquid aerosol, or a liquid wipe. Unexpectedly, the IBF can comprise any suitable biocide where the MIC of the biocide, independent of chemical structure, appears to be reduced by the presence of a biochelant of the type disclosed herein.

### EXAMPLES

The subject matter having been generally described, the following examples are given as particular aspects of the disclosure and are included to demonstrate the practice and advantages thereof, as well as aspects and features of the presently disclosed subject matter. It should be appreciated by those of skill in the art that the techniques disclosed in the examples which follow represent techniques discovered by the inventors to function well in the practice of the present subject matter, and thus can be considered to constitute preferred modes for its practice. However, those of skill in the art should, in light of the present disclosure, appreciate that many changes can be made in the specific aspects which are disclosed and still obtain a like or similar result without departing from the scope of the instant disclosure. It is understood that the examples are given by way of illustration and are not intended to limit the specification of the claims to follow in any manner. The following abbreviations:

Glut: glutaraldehyde, THPS: tetrakis hydroxymethyl-phosphonium sulfate, bronopol: 2-bromo-2-nitro-1,3-propanediol, ADBAC: alkyldimethylbenzylammonium chloride. DDAC: didecyldimethylammonium chloride; G050: gluconic acid; GA50: glucaric acid; GOGA45: A mixture of gluconic acid, glucaric acid, sodium gluconate, sodium glucarate in equilibrium

### Example 1

The ability of an BF to inhibit microorganisms was investigated. Specifically, three bacteria types were tested to compare the MIC of a biocide, a biochelant and IBFs of the present disclosure. The bacteria types utilized were isolated from produced water from the Marcellus shale formation, and identified as (i) general aerobic bacteria identified as Pseudomonas aeruginosa and Enterobacter aggolomerans (ii) Wild strain sulfate reducing bacteria and (iii) acid producing bacteria. General aerobic bacteria aid in the formation of biofilms. Most of these bacteria will be found either floating freely in water (planktonic organisms) or will be attached to various surfaces (sessile organisms). Wild strain Sulfate Reducing Bacteria and Acid Producing Bacteria isolated from the produced fluid was also used. Wild strain Sulfate Reducing Bacteria (WSRB) are the most common anaerobic organisms found in the oil and gas industry. WSRB are an issue as they will reduce sulfate into sulfides which can turn into hydrogen sulfide, souring the fluid in the oil and gas well.

The bacteria tested were placed in a microtiter plate, where a high throughput test was performed to determine MIC (minimum inhibitor concentration). The biocides were tested at the following doses (1000, 500, 250,125, 62.5, 31.2, 15.6, 7.8, 3.9, and 1.95 ppm), and the biochelants were tested at the following doses (10,000, 5000, 2500, 1250, 625, 312.5, 156.25, 78.125, 39.06, and 19.53 ppm). The BE contained 1:1 biocide:biochelant each at 50 ppm. The testing results are presented in Table 1.

TABLE 2

| | Wild Strain | | |
|---|---|---|---|
| | General | Wild Strain | Wild Strain |
| | Bacteria | SRB | APB |
| Compounds | MIC [ppm] | | |
| 50% Glut | 1000 | 500 | 500 |
| 50% Glut + GO50 | 2000 | 2000 | 2000 |
| 50% Glut + GA50 | 500 | 2000 | 2000 |
| 50% Glut + GOGA45 | 2000 | 2000 | 2000 |
| 75% THPS | 1000 | 1000 | 62.5 |
| 75% THPS + GO50 | 1000 | 500 | 1.95 |
| 75% THPS + GA50 | 1000 | 250 | 1.95 |
| 75% THPS + GOGA45 | 1000 | 1000 | 1.95 |
| 10% BRONOPOL | 125 | 125 | 62.5 |
| 10% BRONOPOL + GO50 | 1.95 | 250 | 1000 |
| 10% BRONOPOL + GA50 | 1000 | 1000 | 1000 |
| 10% BRONOPOL + | 1000 | 1000 | 1000 |
| GOGA45 | | | |
| 80% ADBAC/10% DDAC | 31.25 | 15.6 | 3.9 |
| 80% ADBAC/10% DDAC + | 1.95 | 1.95 | 1.95 |
| GO50 | | | |
| 80% ADBAC/10% DDAC + | 1.95 | 1.95 | 1.95 |
| GA50 | | | |
| 80% ADBAC/10% DDAC + | 1.95 | 1.95 | 1.95 |
| GOGA45 | | | |
| G050 | 10000 | 312.5 | 625 |
| GA50 | 2500 | 625 | 625 |
| GOGA45 | 10000 | 5000 | 2500 |

As seen in Table 1, an IBF of the type disclosed herein led to reductions in the MIC of various biocides. Also, BIOCHELATE™ performance by itself had MICs below some of the other biocides for the Wild Strain SRB. With respect to ADBAC/DDAC, the use of BIOCHELATE products led to a maximum MIC reduction of 94%. With respect to bronopol the use of biochelants of the type disclosed herein in conjunction with bronopol led to a maximum MIC reduction of 98%. With respect to THPS, the use of a biochelant of the type disclosed herein in conjunction with the THPS led to a maximum MIC reduction of 97%.

### Example 2

The ability of an IBF to inhibit microorganisms was investigated. The biocides used were tributyl tetradecyl phosphonium chloride (TTPC, BELLACIDE 350) and household bleach.

TABLE 2

| | General Wild Strain |
|---|---|
| | Bacteria |
| Biocide | MIC [ppm] |
| Bellacide 350 (TTPC) | 500 |
| Household Bleach | 500 |
| GO50 | 10000 |
| GOGA 45 | 10000 |
| GA50 | 2500 |
| Bellacide 350 (TTPC) + GO50 | 15.6 |
| Bellacide 350 (TTPC) + GOGA 45 | 31.25 |
| Bellacide 350 (TTPC) + GA50 | 15.6 |
| Household Bleach + GO50 | 500 |
| Household Bleach + GOGA 45 | 500 |
| Household Bleach + GA50 | 500 |

As seen from the results presented in Table 2, an IBF of the type disclosed herein did not change the MIC of household bleach. However, there was a reduced MIC for the IBF containing TTPC. As seen in Table 2, the MIC for TTPC is 500 ppm. When as a component of an IBF, the TTPC has a MIC reduced to 15.6 ppm.

### Example 3

The ability of an IBF to inhibit microorganisms was investigated. The biocides used as components of the IBF were quaternary ammonium compounds. Specially, the biocides were alkyl dimethyl benzyl ammonium chloride+alkyl dimethyl ethylbenzyl ammonium chloride (Pilot MQ2525M), alkyl dimethyl benzyl ammonium chloride+alkyl dimethyl ethylbenzyl ammonium chloride (Stepan BTC 2125M), alkyl dimethyl benzyl ammonium chloride+octyl decyl dimethyl ammonium chloride+dioctyl dimethyl ammonium chloride+dodecyl dimethyl ammonium chloride (Bardac 205M). The bacterial strains tested were Pseudomonas aeruginosa, Staphylococcus aureus, Escherichia coli and Klebsiella pneumoniae. The MIC results are shown in Table 3.

TABLE 3

| | Pseudo- | Staphylo- | Esche- | |
|---|---|---|---|---|
| | monas | coccus | richia | Klebsiellia |
| | Aeruginosa | Aureus | Coli | Pneumoniae |
| | MIC | MIC | MIC | MIC |
| Biocide | [ppm] | [ppm] | [ppm] | [ppm] |
| MQ 2525M | 125 | 31.25 | 125 | 62.5 |
| BTC 2125M | 125 | 31.25 | 125 | 7.8 |
| Bardac 205M | 15.6 | 7.8 | 62.5 | 1.95 |
| GO50 | 5000 | 5000 | 5000 | 5000 |
| GOGA 45 | 10000 | 10000 | 10000 | 10000 |
| GA50 | 1250 | 5000 | 625 | 1250 |
| MQ 2525M + | 62.5 | 250 | 62.5 | 1.95 |
| GO50 | | | | |
| MQ 2525M + | 62.5 | 1.9 | 250 | 1.95 |
| GOGA 45 | | | | |
| MQ 2525M + GA50 | 62.5 | 7.5 | 62.5 | 1.95 |
| BTC 2125M + | 62.5 | 7.5 | 62.5 | 31.25 |
| GO50 | | | | |
| BTC 2125M + | 62.5 | 7.5 | 250 | 1.95 |
| GOGA 45 | | | | |
| BTC 2125M + | 62.5 | 7.5 | 62.5 | 1.95 |
| GA50 | | | | |
| Bardac 205M + | 31.25 | 7.5 | 31.25 | 1.95 |
| MQ 2525M + | | | | |
| GO50 | | | | |
| Bardac 205M + | 31.25 | 7.5 | 31.25 | 1.95 |
| MQ 2525M + | | | | |
| GOGA 45 | | | | |
| Bardac 205M + | 31.25 | 7.5 | 31.25 | 1.95 |
| MQ 2525M + GA50 | | | | |

As seen in Table 3, synergistic effects were observed, as noted as a reduction in the MIC of the biocide, for the following combinations:

TABLE 3

| Organism | IBF exhibiting reduced MIC |
|---|---|
| P. aeruginosa | MQ 2525M + GO50, GOGA45, GA50 |
| | BTC 2125M + GO50, GOGA45, GA50 |
| S. aureus | MQ 2525M + GOGA45, GA50 |
| | BTC 2125M + GO50, GOGA45, GA50 |
| | BARDAC 205M + GO50, GOGA45, GA50 |
| E. coli | MQ 2525M + GO50, GA50 |
| | BTC 2125M + GO50, GA50 |
| | BARDAC 205M + GO50, GOGA45, GA50 |
| K. pneumoniae | MQ 2525M + GO50, GOGA45, GA50 |
| | BTC 2125M + GOGA45 + GA50 |

### ADDITIONAL DISCLOSURE

The following are non-limiting, specific aspects in accordance with the present disclosure:

A first aspect which is a composition for a synergistic biocide or pesticide, the composition comprising a chelant comprising an aldonic, uronic, or aldaric acid, or a salt or derivative thereof, or a combination thereof; a biocide of aldehydes, quaternary ammonium cation, brominated organic compounds, phosphonium salts, hydrogen peroxide, peracetic acid, bleach, and any combinations or derivatives thereof; a solvent comprising water, glycols, and alcohols.

A second aspect which is composition of the first aspect in which the chelant is gluconic acid.

A third aspect which is the composition of any of the first through second aspects wherein the chelant is a mixture of aldaric, uronic acids.

A third aspect which is the composition of any of the first through second aspects wherein the chelant is a mixture of aldaric, uronic acid, and their respective counter-cation.

A fourth aspect which is the composition of any of the first through third aspects wherein the chelant is comprised of glucaric acid, gluconic acid, glucuronic acid, glucose oxidation products, and gluconic acid oxidation products.

A fifth aspect which is the composition of any of the first through fourth aspects wherein the chelant is comprised of sugar oxidation products comprising of disaccharides, oxidized disaccharides, uronic acid, and aldaric acid.

A sixth aspect which is the composition of any of the first through fifth aspects wherein the chelant is comprised of gluconic acid, glucaric acid, glucuronic acid, n-keto-acids and C₂-C₆ diacids.

A seventh aspect which is the composition of any of the first through sixth aspects wherein the counter-cation comprises of an alkali earth metal of group 1 and group 2.

An eighth aspect, which is the composition of any of the first through seventh aspects wherein the counter-cation comprises of ammonium.

A ninth aspect which is a method of treating process water comprising introducing to a system comprising process water a composition comprising (i) one or more biocides and (ii) one or more biochelants.

A tenth aspect which is the method of the ninth aspect wherein the one or more biochelants comprise aldonic acid, uronic acid, aldaric acid, a glucose oxidation product, a gluconic acid oxidation product, a gluconate, glucaric acid, gluconic acid, glucuronic acid, comprises galactonic acid, galactaric acid, an oxidation product comprising predominantly galactonic acid and/or galactaric acid with minor component species of n-keto-acids, C₂ to C₆ diacids or a combination thereof.

An eleventh aspect which is the method of any of the ninth through tenth aspects wherein the one or more biochelants further comprise a counteraction.

A twelfth aspect which is the method of the eleventh aspect wherein the counteraction comprises silicates, borates, aluminum, calcium, magnesium, ammonium, sodium, potassium, cesium, strontium, zinc, copper, ferric iron, ferrous iron, or a combination thereof.

A thirteenth aspect which is the method of any of the ninth through twelfth aspects wherein the biocide comprises aldehydes, quaternary ammonium cations, brominated organic compounds, phosphonium salts, hydrogen peroxide, peracetic acid, bleach, chlorides, citric acid, derivatives thereof, or a combination thereof.

A fourteenth aspect which is the method of any of the ninth through thirteenth aspects wherein the biocide comprises 2,2-dibromo-3-nitrilopropionamide (DBNPA), tetrakis hydroxymethyl-phosphonium sulfates, bronopol, (+)-tartaric acid, (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (13Z)-Hexadec-13-en-11-yn-1-yl acetate, (9Z,12E)-tetradeca-9,12-dien-1-yl acetate, (benzothiazol-2-ylthio)methyl thiocyanate (TCMTB), benzyloxy)methanol, ((E)-1-(2-Chloro-1,3-thiazol-5-ylmethyl)-3-methyl-2-nitroguanidine (Clothianidin), (ethylenedioxy)dimethanol (Reaction products of ethylene glycol with paraformaldehyde (EGForm)), (RS)-3-Allyl-2-methyl-4-oxocyclopent-2-enyl (1R,3R)-2,2-dimethyl-3-(2-methyl prop-1-enyl)-cyclopropanecarboxylate (mixture of 2 isomers 1R trans: 1R/S only 1:3) (Esbiothrin), (1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1) (d-Allethrin), (RS)-α-cyano-3phenoxybenzyl-(1 RS)-cis, trans-3-(2,2-dichlorovinyl)-2,2-dimethylcyclopropanecarboxylate (Cypermethrin), 1,2-benzisothiazol-3(2H)-one (BIT), 1,3-bis(hydroxymethyl)-5,5-dimethylimidazolidine-2,4-dione (DMDMH), 1-[2-(allyloxy)-2-(2,4-dichlorophenyl)ethyl]-1H-imidazole (Imazalil), 2,2-dibromo-2-cyanoacetamide (DBNPA), 2,2′,2″-(hexahydro-1,3,5-triazine-1,3,5-triyl)triethanol (HHT), 4,4-dimethyloxazolidine, 4,5-Dichloro-2-octylisothiazol-3(2H)-one (4,5-Dichloro-2-octyl-2H-isothiazol-3-one (DCOIT)), 4-bromo-2-(4-chlorophenyl)-1-ethoxy methyl-5-trifluoromethylpyrrole-3-carbonitrile (Chlorfenapyr), 4-bromo-2-(4-chlorophenyl)-1-ethoxy methyl-5-trifluoromethylpyrrole-3-carbonitrile (Chlorfenapyr), 5-chloro-2-(4-chlorphenoxy)phenol (DCPP), 6-(phthalimido)peroxyhexanoic acid (PAP), 7a-ethyldihydro-1H,3H,5H-oxazolo[3,4-c]oxazole (EDHO), tetrakis(hydroxymethyl)phosphonium sulfate (THPS), and tetrakis(hydroxymethyl)phosphonium chloride (THPC) or a combination thereof.

A fifteenth aspect which is the method of any of the ninth through fourteenth aspects wherein a biocide:biochelant ratio is from about 1:100 to about 100:1.

A sixteenth aspect which is the method of any of the ninth through fifteenth aspects wherein the composition further comprises a solvent.

A seventeenth aspect which is the method of the sixteenth aspect wherein the solvent comprises an alcohol.

An eighteenth aspect which is the method of any of the ninth through seventeenth aspects wherein the solvent comprises an aqueous fluid.

A nineteenth aspect which is the method of the eighteenth aspect wherein the aqueous fluid comprises fresh water, salt water, deionized water, produced water, flowback water, brackish water, brine, seawater, or a combination thereof.

A twentieth aspect which is the method of the nineteenth aspect wherein the system comprises cooling towers, boilers, evaporators, heat exchangers, chillers, reverse osmosis/filtration systems, and distillation/separation processes or a combination thereof.

A twenty-first aspect which is a composition comprising (i) one or more biocides and (ii) one or more biochelants.

A twenty-second aspect which is the composition of the twenty-first aspect wherein the one or more biochelants comprise aldonic acid, uronic acid, aldaric acid, a glucose oxidation product, a gluconic acid oxidation product, a gluconate, glucaric acid, gluconic acid, glucuronic acid, comprises galactonic acid, galactaric acid, an oxidation product comprising predominantly galactonic acid and/or galactaric acid with minor component species of n-keto-acids, C₂ to C₆ diacids or a combination thereof.

A twenty-third aspect which is the composition of the twenty-first aspect wherein the one or more biochelants further comprise a counteraction.

A twenty-fourth aspect which is the composition of the twenty-third aspect wherein the counteraction comprises silicates, borates, aluminum, calcium, magnesium, ammonium, sodium, potassium, zinc, copper, ferric iron, ferrous iron, cesium, strontium or a combination thereof.

A twenty-fifth aspect which is the composition of the twenty-first aspect wherein the one or more biocides comprise aldehydes, quaternary ammonium cations, brominated organic compounds, phosphonium salts, hydrogen peroxide, peracetic acid, bleach, chlorides, citric acid, derivatives thereof, or a combination thereof.

A twenty-sixth aspect which is the composition of the twenty-first aspect wherein the one or more biocide comprise 2,2-dibromo-3-nitrilopropionamide (DBNPA), tetrakis hydroxymethyl-phosphonium sulfates, bronopol, (+)-tartaric acid, (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (13Z)-Hexadec-13-en-11-yn-1-yl acetate, (9Z,12E)-tetradeca-9,12-dien-1-yl acetate, (benzothiazol-2-ylthio)methyl thiocyanate (TCMTB), benzyloxy)methanol, ((E)-1-(2-Chloro-1,3-thiazol-5-ylmethyl)-3-methyl-2-nitroguanidine (Clothianidin), (ethylenedioxy)dimethanol (Reaction products of ethylene glycol with paraformaldehyde (EGForm)), (RS)-3-Allyl-2-methyl-4-oxocyclopent-2-enyl (1R,3R)-2,2-dimethyl-3-(2-methyl prop-1-enyl)-cyclopropanecarboxylate (mixture of 2 isomers 1R trans: 1R/S only 1:3) (Esbiothrin), (1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1) (d-Allethrin), (RS)-α-cyano-3phenoxybenzyl-(1 RS)-cis, trans-3-(2,2-dichlorovinyl)-2,2-dimethylcyclopropanecarboxylate (Cypermethrin), 1,2-benzisothiazol-3(2H)-one (BIT), 1,3-bis(hydroxymethyl)-5,5-dimethylimidazolidine-2,4-dione (DMDMH), 1-[2-(allyloxy)-2-(2,4-dichlorophenyl)ethyl]-1H-imidazole (Imazalil), 2,2-dibromo-2-cyanoacetamide (DBNPA), 2,2′,2″-(hexahydro-1,3,5-triazine-1,3,5-triyl)triethanol (HHT), 4,4-dimethyloxazolidine, 4,5-Dichloro-2-octylisothiazol-3(2H)-one (4,5-Dichloro-2-octyl-2H-isothiazol-3-one (DCOIT)), 4-bromo-2-(4-chlorophenyl)-1-ethoxy methyl-5-trifluoromethylpyrrole-3-carbonitrile (Chlorfenapyr), 4-bromo-2-(4-chlorophenyl)-1-ethoxy methyl-5-trifluoromethylpyrrole-3-carbonitrile (Chlorfenapyr), 5-chloro-2-(4-chlorphenoxy)phenol (DCPP), 6-(phthalimido)peroxyhexanoic acid (PAP), 7a-ethyldihydro-1H,3H,5H-oxazolo[3,4-c]oxazole (EDHO), tetrakis(hydroxymethyl)phosphonium sulfate (THPS), and tetrakis(hydroxymethyl)phosphonium chloride (THPC) or a combination thereof.

A twenty-seventh aspect which is the composition of the twenty-first aspect wherein the minimum inhibitory concentration is reduced by from about 5% to about 100% when compared to the minimum inhibitory concentration of the at least one biocide.

A twenty-eight aspect which is a pharmaceutical formulation comprising (i) one or more biocides (ii) one or more biochelant sand (iii) a pharmaceutically acceptable diluent.

While aspects of the disclosure have been shown and described, modifications thereof can be made without departing from the spirit and teachings of the presently disclosed subject matter. The aspects and examples described herein are exemplary only, and are not intended to be limiting. Many variations and modifications of the subject matter disclosed herein are possible and are within the scope of the present disclosure.

At least one aspect is disclosed and variations, combinations, and/or modifications of the aspect(s) and/or features of the aspect(s) made by a person having ordinary skill in the art are within the scope of the disclosure. Alternative aspects that result from combining, integrating, and/or omitting features of the aspect(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . , greater than 0.10 includes 0.11, 0.12, 0.13, 0.14, 0.15, . . . ). For example, whenever a numerical range with a lower limit, Ri, and an upper limit, Rᵤ, is disclosed, any number falling within the range is specifically disclosed. In particular, the following numbers within the range are specifically disclosed: R=Rₗ+k* (Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the detailed description of the presently disclosed subject matter.

1. A method of treating process water, the method comprising:
introducing to a system comprising process water a composition comprising (i) one or more biocides and (ii) one or more biochelants comprising gluconic acid or salts thereof and glucaric acid or salts thereof, with minor component species of n-keto-acids, C₂ to C₆ diacids or a combination thereof,
wherein a ratio of the one or more biocides to the one or more biochelants is from about 10:90 to about 90:10.

2. (canceled)

3. The method of claim 1, wherein the one or more biochelants further comprise a counter-cation.

4. The method of claim 3, wherein the counter-cation comprises silicates, borates, aluminum, calcium, magnesium, zinc, copper, ferric iron, ferrous iron, ammonium, sodium, potassium, cesium, strontium or a combination thereof.

5. The method of claim 1, wherein the biocide comprises aldehydes, quaternary ammonium cations, brominated organic compounds, phosphonium salts, hydrogen peroxide, peracetic acid, bleach, chlorides, citric acid, derivatives thereof, or a combination thereof.

6. The method of claim 1, wherein the biocide comprises 2,2-dibromo-3-nitrilopropionamide (DBNPA), tetrakis hydroxymethyl-phosphonium sulfates, bronopol, (+)-tartaric acid, (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (13Z)-Hexadec-13-en-11-yn-1-yl acetate, (9Z,12E)-tetradeca-9,12-dien-1-yl acetate, (benzothiazol-2-ylthio)methyl thiocyanate (TCMTB), benzyloxy)methanol, ((E)-1-(2-Chloro-1,3-thiazol-5-ylmethyl)-3-methyl-2-nitroguanidine (Clothianidin), (ethylenedioxy)dimethanol (Reaction products of ethylene glycol with paraformaldehyde (EGForm)), (RS)-3-Allyl-2-methyl-4-oxocyclopent-2-enyl (1R,3R)-2,2-dimethyl-3-(2-methyl prop-1-enyl)-cyclopropanecarboxylate (mixture of 2 isomers 1R trans: 1R/S only 1:3) (Esbiothrin), (1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1) (d-Allethrin), (RS)-α-cyano-3phenoxybenzyl-(1RS)-cis, trans-3-(2,2-dichlorovinyl)-2,2-dimethylcyclopropanecarboxylate (Cypermethrin), 1,2-benzisothiazol-3(2H)-one (BIT), 1,3-bis(hydroxymethyl)-5,5-dimethylimidazolidine-2,4-dione (DMDMH), 1-[2-(allyloxy)-2-(2,4-dichlorophenyl)ethyl]-1H-imidazole (Imazalil), 2,2-dibromo-2-cyanoacetamide (DBNPA), 2,2′,2″-(hexahydro-1,3,5-triazine-1,3,5-triyl)triethanol (HHT), 4,4-dimethyloxazolidine, 4,5-Dichloro-2-octylisothiazol-3(2H)-one (4,5-Dichloro-2-octyl-2H-isothiazol-3-one (DCOIT)), 4-bromo-2-(4-chlorophenyl)-1-ethoxy methyl-5-trifluoromethylpyrrole-3-carbonitrile (Chlorfenapyr), 4-bromo-2-(4-chlorophenyl)-1-ethoxy methyl-5-trifluoromethylpyrrole-3-carbonitrile (Chlorfenapyr), 5-chloro-2-(4-chlorphenoxy)phenol (DCPP), 6-(phthalimido)peroxyhexanoic acid (PAP), 7a-ethyldihydro-1H,3H,5H-oxazolo[3,4-c]oxazole (EDHO), tetrakis(hydroxymethyl)phosphonium sulfate (THPS), and tetrakis(hydroxymethyl)phosphonium chloride (THPC) or a combination thereof.

7. (canceled)

8. The method of claim 1, wherein the composition further comprises a solvent.

9. The method of claim 8, wherein the solvent comprises an alcohol.

10. The method of claim 1, wherein the solvent comprises an aqueous fluid.

11. The method of claim 10, wherein the aqueous fluid comprises fresh water, salt water, deionized water, produced water, flowback water, brackish water, brine, seawater, or a combination thereof.

12. The method of claim 1, wherein the system comprises cooling towers, boilers, evaporators, heat exchangers, chillers, reverse osmosis/filtration systems, and distillation/separation processes or a combination thereof.

13. A composition, comprising:
(i) one or more biocides; and
(ii) one or more biochelants comprising gluconic acid or salts thereof and glucaric acid or salts thereof, with minor component species of n-keto-acids, C₂ to C₆ diacids or a combination thereof,
wherein a ratio of the one or more biocides to the one or more biochelants is from about 10:90 to about 90:10.

14. (canceled)

15. The composition of claim 13, wherein the one or more biochelants further comprise a counter-cation.

16. The composition of claim 15, wherein the counter-cation comprises silicates, borates, aluminum, calcium, magnesium, ammonium, sodium, potassium, cesium, strontium, zinc, copper, ferric iron, ferrous iron or a combination thereof.

17. The composition of claim 13, wherein the one or more biocides comprise aldehydes, quaternary ammonium cations, brominated organic compounds, phosphonium salts, hydrogen peroxide, peracetic acid, bleach, chlorides, citric acid, derivatives thereof, or a combination thereof.

18. The composition of claim 13, wherein the one or more biocides comprise 2,2-dibromo-3-nitrilopropionamide (DBNPA), tetrakis hydroxymethyl-phosphonium sulfates, bronopol, (+)-tartaric acid, (1,3,4,5,6,7-hexahydro-1,3-dioxo-2H-isoindol-2-yl)methyl (1R-trans)-2,2-dimethyl-3-(2-methylprop-1-enyl)cyclopropanecarboxylate (d-Tetramethrin), (13Z)-Hexadec-13-en-11-yn-1-yl acetate, (9Z,12E)-tetradeca-9,12-dien-1-yl acetate, (benzothiazol-2-ylthio)methyl thiocyanate (TCMTB), benzyloxy)methanol, ((E)-1-(2-Chloro-1,3-thiazol-5-ylmethyl)-3-methyl-2-nitroguanidine (Clothianidin), (ethylenedioxy)dimethanol (Reaction products of ethylene glycol with paraformaldehyde (EGForm)), (RS)-3-Allyl-2-methyl-4-oxocyclopent-2-enyl (1R,3R)-2,2-dimethyl-3-(2-methyl prop-1-enyl)-cyclopropanecarboxylate (mixture of 2 isomers 1R trans: 1R/S only 1:3) (Esbiothrin), (1R,3S)-2,2-dimethyl-3-(2-methylprop-1-enyl)-cyclopropanecarboxy late (mixture of 4 isomers 1R trans, 1R:1R trans, 1S: 1R cis, 1R: 1R cis,1S 4:4:1:1) (d-Allethrin), (RS)-α-cyano-3phenoxybenzyl-(1RS)-cis, trans-3-(2,2-dichlorovinyl)-2,2-dimethylcyclopropanecarboxylate (Cypermethrin), 1,2-benzisothiazol-3(2H)-one (BIT), 1,3-bis(hydroxymethyl)-5,5-dimethylimidazolidine-2,4-dione (DMDMH), 1-[2-(allyloxy)-2-(2,4-dichlorophenyl)ethyl]-1H-imidazole (Imazalil), 2,2-dibromo-2-cyanoacetamide (DBNPA), 2,2′,2″-(hexahydro-1,3,5-triazine-1,3,5-triyl)triethanol (HHT), 4,4-dimethyloxazolidine, 4,5-Dichloro-2-octylisothiazol-3(2H)-one (4,5-Dichloro-2-octyl-2H-isothiazol-3-one (DCOIT)), 4-bromo-2-(4-chlorophenyl)-1-ethoxy methyl-5-trifluoromethylpyrrole-3-carbonitrile (Chlorfenapyr), 4-bromo-2-(4-chlorophenyl)-1-ethoxy methyl-5-trifluoromethylpyrrole-3-carbonitrile (Chlorfenapyr), 5-chloro-2-(4-chlorphenoxy)phenol (DCPP), 6-(phthalimido)peroxyhexanoic acid (PAP), 7a-ethyldihydro-1H,3H,5H-oxazolo[3,4-c]oxazole (EDHO), tetrakis(hydroxymethyl)phosphonium sulfate (THPS), and tetrakis(hydroxymethyl)phosphonium chloride (THPC) or a combination thereof.

19. The composition of claim 13, wherein a minimum inhibitory concentration of the composition is reduced by from about 5% to about 100% when compared to a minimum inhibitory concentration of the at least one biocide in an absence of the one or more biochelants.

20. A pharmaceutical formulation, comprising:
(i) one or more biocides;
(ii) one or more biochelants comprising gluconic acid or salts thereof and glucaric acid or salts thereof, with minor component species of n-keto-acids, C₂ to C₆ diacids or a combination thereof; and
(iii) a diluent,
wherein a ratio of the one or more biocides to the one or more biochelants is from about 10:90 to about 90:10.

21. The method of claim 1, wherein the ratio of the one or more biocides to the one or more biochelants is from about 20:80 to about 80:20.

22. The composition of claim 13, wherein the ratio of the one or more biocides to the one or more biochelants is from about 20:80 to about 80:20.

23. The pharmaceutical formulation of claim 20, wherein the ratio of the one or more biocides to the one or more biochelants is from about 20:80 to about 80:20.
